(19) United States
(12) Patent Application Publication
(10) Pub. No.: US 2026/0350454 A1
(43) Pub. Date: Nov. 5, 2026

(54) ASYMPTOTICALLY BIAS-FREE ERROR MITIGATION WITH BOUNDED RESIDUAL BIAS

(71) Applicant: International Business Machines Corporation, Armonk, NY (US)

(72) Inventors: Luke Colin Gene Govia, Sunnyvale, CA (US); Mirko Amico, Pacific Palisades, CA (US); Zlatko Kristev Minev, White Plains, NY (US); Swarnadeep Majumder, Durham, NC (US)

(21) Appl. No.: 19/196,006

(22) Filed: May 1, 2025

(51) Int. Cl. G06N 10/70

(52) U.S. Cl. CPC G06N 10/70

(57) ABSTRACT

Systems/techniques that facilitate asymptotically bias-free error mitigation with bounded residual bias are provided. In various embodiments, a system can comprise a memory that stores computer executable components. In various embodiments, the system can further comprise a processor that executes the computer executable components stored in the memory, wherein the computer executable components can comprise an access component that can receive a mitigated expectation value of a target circuit using an error mitigation protocol. In various instances, the computer executable components can further comprise a correction component that can correct a residual bias error of the mitigated expectation value for the error mitigation protocol using classical executions and quantum executions of an ensemble of circuits.

### BACKGROUND

The subject disclosure relates to quantum computing, and more specifically to asymptotically bias-free error mitigation with bounded residual bias.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate asymptotically bias-free error mitigation with bounded residual bias are described.

According to one or more embodiments, a system is provided. In various aspects, the system can comprise a memory that stores computer executable components. In various embodiments, the system can further comprise a processor that executes the computer executable components stored in the memory, wherein the computer executable components can comprise an access component that can receive a mitigated expectation value of a target circuit using an error mitigation protocol. In various instances, the computer executable components can further comprise a correction component that can correct a residual bias error of the mitigated expectation value for the error mitigation protocol using classical executions and quantum executions of an ensemble of circuits.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates asymptotically bias-free error mitigation with bounded residual bias in accordance with one or more embodiments described herein.

FIG. 2 illustrates another block diagram of an example, non-limiting system that facilitates asymptotically bias-free error mitigation with bounded residual bias in accordance with one or more embodiments described herein.

FIG. 3 illustrates an example, non-limiting diagram showing asymptotically bias-free error mitigation with bounded residual bias in accordance with one or more embodiments described herein.

FIG. 4 illustrates an example, non-limiting diagram showing asymptotically bias-free error mitigation with bounded residual bias in accordance with one or more embodiments described herein.

FIG. 5 illustrates an example, non-limiting diagram showing circuit average ensemble series expansion rescaling in accordance with one or more embodiments described herein.

FIG. 6 illustrates an example, non-limiting diagram showing circuit average ensemble series expansion rescaling in accordance with one or more embodiments described herein.

FIG. 7 illustrates an example, non-limiting block diagram showing circuit average ensemble series expansion rescaling in accordance with one or more embodiments described herein.

FIG. 8 illustrates an example, non-limiting diagram of simulation results of circuit average ensemble series expansion rescaling in accordance with one or more embodiments described herein.

FIG. 9 illustrates an example, non-limiting diagram of simulation results of circuit average ensemble series expansion rescaling in accordance with one or more embodiments described herein.

FIG. 10 illustrates a flow diagram of an example, non-limiting computer-implemented method that facilitates asymptotically bias-free error mitigation with bounded residual bias in accordance with one or more embodiments described herein.

FIGS. 11 and 12 illustrate a flow diagram of an example, non-limiting computer-implemented method that facilitates asymptotically bias-free error mitigation with bounded residual bias in accordance with one or more embodiments described herein.

FIGS. 13 and 14 illustrate a flow diagram of an example, non-limiting computer-implemented method that facilitates circuit average ensemble series expansion rescaling in accordance with one or more embodiments described herein.

FIG. 15 illustrates a flow diagram of an example, non-limiting computer-implemented method that facilitates circuit average ensemble series expansion rescaling in accordance with one or more embodiments described herein.

FIG. 16 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to one or more embodiments, a system is provided. In various aspects, the system can comprise a memory that stores computer executable components. In various embodiments, the system can further comprise a processor executes the computer executable components stored in the memory, wherein the computer executable components can comprise an access component that receives a mitigated expectation value of a target circuit using an error mitigation protocol. In various instances, the computer executable components can further comprise a correction component that corrects a residual bias error of the mitigated expectation value for the error mitigation protocol using classical executions and quantum executions of an ensemble of circuits. Such embodiments of the system can provide a number of advantages, including improving accuracy of error mitigation results, bounding residual bias error in error mitigation, enabling asymptotically bias-free error mitigation, and reducing an impact of model learning inaccuracy, model violations, or noise drifts.

According to one or more embodiments of the aforementioned system, the correction component can transform the error mitigation protocol into an asymptotically bias free protocol. Such embodiments of the system can provide a number of advantages, including improving accuracy of error mitigation results and improving accuracy of any error mitigation protocol.

According to one or more embodiments of the aforementioned system, the computer executable components can further comprise a decomposition component that can decompose the target circuit into the ensemble of circuits, wherein the ensemble of circuits is classically simulable. Such embodiments of the system can provide a number of advantages, including improving accuracy of error mitigation results by enabling estimation of the residual bias error and reducing an impact of model learning inaccuracy, model violations, or noise drifts.

According to one or more embodiments of the aforementioned system, the computer executable components can further comprise an execution component that can apply the error mitigation protocol to the ensemble of circuits. Such embodiments of the system can provide the advantage of improving accuracy of any error mitigation protocol by enabling estimation of the residual bias error.

According to one or more embodiments of the aforementioned system, wherein an execution component can perform the quantum executions of the ensemble of circuits or quantum executions of the target circuit simultaneously on a quantum processor. Such embodiments of the system can provide a number of advantages, including enabling asymptotically bias-free error mitigation with bounded bias while reducing computational overhead, enabling error mitigation without a learning phase, reducing overhead by containing error mitigation in classical post-processing, and reducing the impact of model drift.

According to one or more embodiments of the aforementioned system, the correction component can determine a set of mitigated expectation values of the ensemble of circuits based on the classical executions and quantum executions of the ensemble of circuits. Such embodiments of the system can provide a number of advantages, including improving accuracy of any error mitigation protocol by enabling estimation of the residual bias.

According to one or more embodiments of the aforementioned system, an execution component can classically simulate the ensemble of circuits to determine a set of ideal expectation values of the ensemble of circuits. Such embodiments of the system can provide a number of advantages, including improving accuracy of any error mitigation protocol by enabling estimation of the residual bias.

According to one or more embodiments of the aforementioned system, the correction component can determine an error term based on the set of mitigated expectation values of the ensemble of circuits and the set of ideal expectation values of the ensemble of circuits. Such embodiments of the system can provide a number of advantages, including improving accuracy of any error mitigation protocol by enabling estimation of the residual bias.

According to one or more embodiments of the aforementioned system, correcting the residual bias error of the mitigated expectation value can comprise determining a second mitigated expectation value of the target circuit that has a bounded bias based on the mitigated expectation value of the target circuit and the error term. Such embodiments of the system can provide a number of advantages, including improving accuracy of any error mitigation protocol by enabling estimation of the residual bias.

According to one or more embodiments of the aforementioned system, an execution component can execute the ensemble of circuits on a quantum processor to determine a first set of unmitigated expectation values of the ensemble of circuits and can classically simulate the ensemble of circuits using a noise model to determine a second set of unmitigated expectation values of the ensemble of circuits. According to one or more embodiments of the aforementioned system the correction component can determine the set of mitigated expectation values of the ensemble of circuits based on the first and second set of unmitigated expectation values. Such embodiments of the system can provide a number of advantages, including enabling prediction of a mitigated expectation value of the ensemble of circuits for estimating the error term, thereby enabling improved error mitigation.

According to one or more embodiments of the aforementioned system, the correction component can determine a rescaling parameter based on the classical executions and quantum executions of the ensemble of circuits. Such embodiments of the system can provide a number of advantages, including improving accuracy of any error mitigation by enabling estimation of the residual bias.

According to one or more embodiments of the aforementioned system, the correction component can rescale an unmitigated expectation value of the target circuit by the rescaling parameter. According to one or more embodiments of the aforementioned system, the correction component can rescale a set of unmitigated expectation values of the ensemble of circuits by the rescaling parameter. Such embodiments of the system can provide a number of advantages, including improving accuracy of any error mitigation by enabling estimation of the residual bias and containing error mitigation in classical post-processing.

According to one or more embodiments of the aforementioned system, the correction component can expand the error term as a series sum over the ensemble of circuits. Such embodiments of the system can provide a number of advantages, including containing error mitigation in classical post-processing and improving accuracy of error mitigation by enabling asymptotically bias-free error mitigation with bounded bias.

In various aspects, the above-described system can be reformulated, reformatted, or otherwise implemented as a computer-implemented method or as a computer program product.

### DEFINITIONS

Bias free error mitigation: An error mitigation protocol is bias free if in its intended operation there is zero residual bias error in a mitigated expectation value, and all remaining error is statistical. For example, Probabilistic Error Cancellation (PEC) has this property, but Zero-Noise Extrapolation (ZNE) does not.

Asymptotically bias free error mitigation: An error mitigation protocol is asymptotically bias free if in its standard operation it has finite bias, but there exists a user-controlled parameter that can be tuned to reduce the bias. In the asymptotic limit of this parameter, the error mitigation protocol becomes bias free.

Bounded bias error mitigation: An error mitigation protocol has bounded bias if there exists a methodology to estimate an upper bound for the bias error.

Clifford Perturbation Theory (CPT): CPT is a classical simulation method for quantum circuits that unravels a quantum circuit into a particular Heisenberg-style simulation.

Quantum systems are inherently prone to noise, causing results of quantum computations to be noisy and prone to errors. Quantum error mitigation (QEM) refers to various techniques designed to reduce the impact of such noise and errors in the quantum computations. Specifically, an error mitigation protocol implements QEM techniques to enhance the reliability of the results on noisy quantum hardware by executing modified quantum circuits and performing classical post-processing to suppress or compensate for noise effects in the quantum computations.

It is often desirable to use quantum systems to estimate expectation values of observables, as these expectation values are critical for understanding physical properties of a quantum system. By measuring observables (e.g., energy, spin, or other quantum properties) quantum systems can provide insights that are difficult or impossible to obtain with classical methods. Accordingly, due to the inherent noise and errors in quantum computations, error mitigation protocols utilize classical and quantum resources to improve the accuracy of the noisy expectation values resulting from the quantum computations.

However, existing methods for error mitigation can be unreliable for various reasons.

First, many quantum error mitigation techniques, such as Clifford Data Regression (CDR), Operator Decoherence Renormalization (ODR), or Zero-Noise Extrapolation (ZNE), lack reliable methods for estimating or controlling the residual bias error (e.g., residual bias) that remains after mitigation. Residual bias error refers to the systematic inaccuracy or error that persists in the results of quantum computations despite the application of error mitigation techniques. More specifically, residual bias error is the difference between an ideal expectation value of a target circuit and a mitigated expectation value of the target circuit. The residual bias error can arise due to several factors, such as limitations in the error model or imperfect mitigation processes. While existing methods for error mitigation aim to reduce noise effects, they do not provide explicit mechanisms to manage the residual bias error, resulting in potentially inaccurate or unreliable mitigated expectation values. In other words, such existing methods do not bound the residual bias error, causing the results of quantum computations to be unreliable. That is, existing methods do not guarantee accuracy of results.

Second, existing methods for error mitigation that are designed to achieve bias-free error mitigation, such as Probabilistic Error Cancellation (PEC), face significant implementation challenges due to a separate learning phase. More specifically, in the separate learning stage, such existing methods learn a noise model. However, the noise model may not be accurate and thus may not be sufficiently expressive to capture all error types. Additionally, since error rates in quantum systems can fluctuate over time, the noise model that was trained on previous data may not be applicable when the quantum system is executing a computation, leading to residual bias. Thus, such existing methods are prone to error drifts (e.g., gradual changes in the error rates of a quantum system over time) or error fluctuations (e.g., rapid, unpredictable variations in error rates caused by environmental noise or operational factors) between the separate learning phase and execution. As a result, even bias-free error mitigation protocols can suffer from inaccuracies due to such limitations caused by the separate learning phase, leading to unreliable error mitigation results.

Third, existing methods for error mitigation are not scalable to large, complex quantum systems. As quantum systems grow in size and complexity, computational resources needed for error mitigation increase significantly. This can lead to increased overhead, in terms of both time and computational power, making the error mitigation process less feasible for large-scale quantum computations. Additionally, many existing error mitigation protocols assume a particular level of accuracy of the noise model or rely on approximations that may not scale well as the quantum system becomes more complex. As a result, such existing error mitigation protocols can provide less reliable results when applied to large quantum circuits, where the errors are more diverse and harder to characterize.

Consequently, these existing methods for error mitigation remain unreliable, limiting their application in practical quantum computing.

The various techniques described herein can help to address or ameliorate various of the above-described technical problems that plague existing techniques for performing error mitigation. In particular, the various embodiments described herein can provide an asymptotically bias-free error mitigation protocol with bounded residual bias so as to help solve such technical problems.

Specifically, various embodiments described herein can involve receiving a target quantum circuit as input and decomposing the target quantum circuit into an ensemble of circuits. As used herein, the term “target quantum circuit” is used interchangeably with “target circuit”. Particularly, the expectation value of the target circuit can be decomposed into a sum of expectation values of the ensemble of circuits, where the ensemble of circuits is classically simulable. That is, each circuit in the ensemble of circuits can be classically simulated.

Then, the various embodiments described herein can execute, on a quantum system (e.g., a quantum processor), the target circuit and apply an error mitigation protocol to determine a mitigated expectation value of the target circuit.

Thereafter, the various embodiments described herein can execute, on the quantum system, the ensemble of circuits to produce a set of mitigated expectation values of the ensemble of circuits as output. Furthermore, the various embodiments described herein can classically simulate the ensemble of circuits to produce a set of ideal expectation values of the ensemble of circuits. Thus, the various embodiments described herein can compare the set of mitigated expectation values to the set of ideal expectation values to estimate the residual bias error in the mitigated expectation value of the target circuit. In this way, the various embodiments described herein can improve the accuracy of the mitigated expectation value of the target circuit iteratively over the circuits in the ensemble of circuits. In other words, the various embodiments described herein can improve the accuracy of the mitigated expectation value by performing additional unmitigated quantum executions and classical executions of the ensemble of circuits.

Such embodiments can provide a number of advantages. Particularly, such embodiments can be applied to any error mitigation protocol. That is, the various embodiments described herein can transform any error mitigation protocol into an asymptotically bias-free error mitigation protocol with bounded bias. Furthermore, such embodiments can be applied to any target circuit. More specifically, the various embodiments described herein do not restrict or place constraints on the target circuit. For example, the target circuit can be a structured circuit or an unstructured circuit. As another example, the target circuit can be a layered circuit or a non-layered circuit (e.g., not requiring a particular layer structure). Thus, the various embodiments described herein can improve the accuracy of error mitigation for any target circuit and any desired error mitigation protocol.

Moreover, the various embodiments described herein can perform error mitigation without learning a noise model. That is, a separate learning phase is not needed to perform error mitigation, reducing the impact of inaccurate learning of noise models, noise model violations, error drifts, or error fluctuations. Furthermore, the target circuit and the ensemble of circuits can be executed simultaneously on the quantum system, further minimizing impacts of error drifts.

Accordingly, various embodiments described herein can be considered as concrete technical improvements in error mitigation.

Various embodiments described herein can be employed to use hardware or software to solve problems that are highly technical in nature (e.g., to facilitate asymptotically bias-free error mitigation with bounded residual bias), that are not abstract and that cannot be performed as a set of mental acts by a human. Further, some of the processes performed can be performed by a specialized computer (e.g., quantum systems comprising tangible qubits that can execute or implement quantum circuits).

Neither the human mind nor a human with pen and paper can: electronically access or receive a target circuit and an error mitigation protocol; electronically decompose the target circuit into an ensemble of circuits; electronically execute the target circuit and the ensemble of circuits on a quantum system; electronically apply the error mitigation protocol to the target circuit and the ensemble of circuits; or electronically execute the ensemble of circuits simultaneously with the target circuit on the quantum system. After all, a quantum system is a specialized piece of computing hardware that utilizes physical qubits (e.g., superconducting qubits, such as transmons) to process information. Physical qubits cannot be implemented by the human mind or by a human with pen and paper. Moreover, a quantum circuit can be a sequence of quantum gates that can be executed on a quantum system. Neither the human mind, nor a human with pen and paper, can transpile or otherwise manipulate quantum gates or execute quantum gates on physical qubits. Also, the very field of quantum error mitigation is focused on electronically executing or implementing quantum circuits on quantum hardware. Therefore, a computerized tool that can facilitate asymptotically bias-free error mitigation with bounded residual bias is an inherently computerized and cannot be implemented in any sensible, practicable, or reasonable way without computers.

In various instances, one or more embodiments described herein can integrate the herein-described teachings into a practical application. As mentioned above, some existing techniques can facilitate error mitigation of a target circuit on quantum system using an error mitigation protocol. Unfortunately, such existing techniques cannot be applied to any target circuit. As also mentioned above, other existing techniques do not correct, manage, or bound residual bias error. Further, as mentioned above, bias-free error mitigation protocols rely on a learning phase to learn a noise model, which can cause inaccuracies in quantum computations due to error drifts or error fluctuations. Thus, such other existing techniques nevertheless suffer from various technical problems.

Accordingly, the various embodiments described herein can be considered as solving, addressing, or otherwise ameliorating the technical problems that afflict such existing techniques. In particular, various embodiments described herein can include enabling asymptotically bias-free error mitigation with bounded residual bias of any target quantum circuit. More specifically, when given a target circuit and an error mitigation protocol, various embodiments described herein can transform the error mitigation protocol into an asymptotically bias-free error mitigation by decomposing the target circuit into an ensemble of circuits and performing quantum and classical executions of the ensemble of circuits. The quantum and classical executions of the ensemble of circuits can provide mitigated expectation values and ideal expectation values that can be used to estimate the residual bias error in a mitigated expectation value of the target circuit using the error mitigation protocol. In doing so, the various embodiments described herein can perform error mitigation without a learning phase, thereby reducing error drift and error fluctuations. Thus, by implementing asymptotically bias-free error mitigation with bounded residual bias, various embodiments described herein can facilitate improved error mitigation of a target circuit, with improved accuracy, and with reduced overhead than existing techniques. For at least these reasons, various embodiments described herein constitute concrete and tangible technical improvements or technical effects in the field of error mitigation and thus certainly qualify as useful and practical applications of computers.

It should be appreciated that the figures and the herein disclosure describe non-limiting examples of various embodiments. It should further be appreciated that the figures are not necessarily drawn to scale.

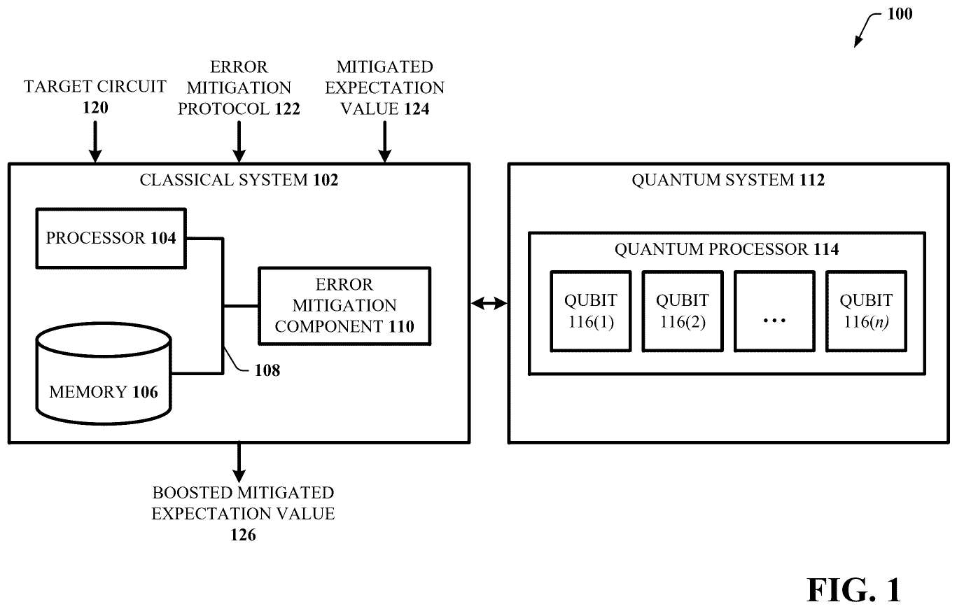

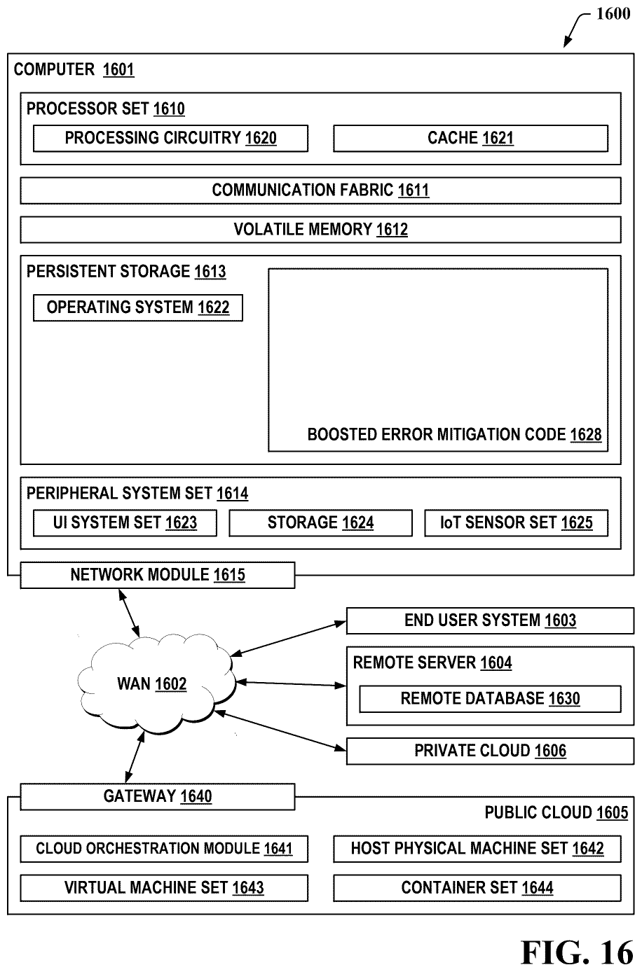

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1600 illustrated at FIG. 16. For example, non-limiting system 100 can be associated with, such as accessible via, a computing environment 1600 described below with reference to FIG. 16, such that aspects of processing can be distributed between non-limiting system 100 and the computing environment 1600. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate asymptotically bias-free error mitigation with bounded residual bias in accordance with one or more embodiments described herein. As shown, a classical system 102 can be electronically integrated, via any suitable wired or wireless electronic connections, with a quantum system 112 or with a target circuit 120.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., error mitigation component 110, access component 202, correction component 204, decomposition component 206, and/or execution component 208) to perform one or more actions. In one or more embodiments, memory 106 can store computer-executable components (e.g., error mitigation component 110, access component 202, correction component 204, decomposition component 206, and execution component 208).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

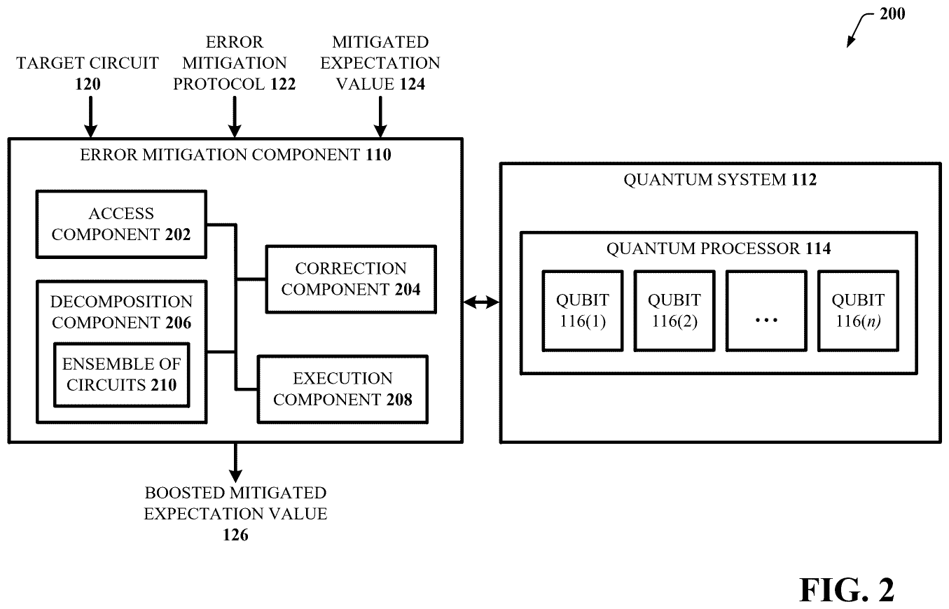

In various embodiments, error mitigation component 110 can comprise access component 202, correction component 204, decomposition component 206, and execution component 208, as illustrated in FIG. 2.

As illustrated in FIG. 1, non-limiting system 100 can comprise classical system 102 and quantum system 112. That is, the non-limiting system 100 can facilitate asymptotically bias-free error mitigation with bounded residual bias, in combination with employment of the quantum system 112. Classical system 102 can be coupled (operatively, communicatively, electrically, and/or like function) to quantum system 112.

In various embodiments, the quantum system 112 can be any suitable quantum computing device or quantum computing hardware. In various aspects, the quantum system 112 can comprise or otherwise include a quantum processor 114. The quantum processor 114 can comprise a set of qubits 116. In various instances, the set of qubits 116 can have n qubits for any suitable positive integer n: a qubit 116(1) to a qubit 116(n). In various cases, any of the set of qubits 116 can exhibit any suitable structure or architecture. As a non-limiting example, any of such qubits can exhibit a superconducting qubit architecture (e.g., such qubit can be constructed from any suitable number of Josephson junctions). As another non-limiting example, any of such qubits can exhibit a quantum dot architecture. As yet another non-limiting example, any of such qubits can exhibit a spin qubit architecture. In various aspects, different qubits of the set of qubits 116 can exhibit the same or different structures or architectures as each other. Although not explicitly shown in FIG. 1, the quantum system 112 can comprise or otherwise be associated with any suitable hardware or software (e.g., real-time controllers implemented in field programmable gate arrays of the quantum system 112) that can be used to initialize any of the set of qubits 116, or that can be used to perform any suitable quantum operations (e.g., quantum gates, qubit measurements, qubit idling) on the set of qubits 116.

In various aspects, the access component 202 can electronically access, in any suitable fashion, the quantum system 112, such that the classical system 102 can electronically activate (e.g., power-up), electronically deactivate (e.g., power-down), or otherwise electronically control the quantum system 112. Furthermore, in various instances, the access component 202 can electronically receive, retrieve, obtain, import, or otherwise access, from any suitable data structures or from any suitable computing devices, the target circuit 120. In any case, the access component 202 can electronically access (e.g., send or receive data or program instructions to or from) the quantum system 112 or the target circuit 120, such that other components of the classical system 102 can electronically interact with the quantum system 112 or with the target circuit 120.

In various instances, the target circuit 120 can be any suitable quantum circuit. As a non-limiting example, the target circuit 120 can be a layered circuit (e.g., a quantum Fourier transform circuit, a variational quantum circuit). As another non-limiting example, the target circuit 120 can be a non-layered circuit (e.g., a quantum phase estimation circuit). By enabling asymptotically bias-free error mitigation with bounded bias of layered or non-layered circuits, the various embodiments described herein can accommodate a wider range of quantum algorithms and quantum hardware architectures, improving the applicability and efficiency of error mitigation.

In various aspects, the access component 202 can electronically receive, retrieve, obtain, import, or otherwise access, from any suitable data structures or from any suitable computing devices, an error mitigation protocol 122. In various embodiments, the error mitigation protocol 122 can be defined based on user input. For instance, a user can specify, via any suitable interface, any desired error mitigation techniques, noise models, or parameters that define error mitigation protocol 122. In other instances, a user can select, via any suitable interface, the error mitigation protocol 122 (e.g., and any corresponding parameters) from a pre-defined list of error mitigation protocols. In any case, the error mitigation protocol 122 can be any suitable error mitigation protocol, such as but not limited to, PEC, ZNE, probabilistic error amplification (PEA), or tensor error mitigation (TEM).

In various cases, the access component 202 can electronically receive, retrieve, obtain, import, or otherwise access, from any suitable data structures or from any suitable computing devices, a mitigated expectation value 124 of the target circuit 120 using error mitigation protocol 122. Alternatively, the execution component 208 can execute, on the quantum system 112, the target circuit 120 using error mitigation protocol 122 to determine the mitigated expectation value 124.

In any case, it can be desirable to reduce the impact of noise and errors on the target circuit 120 by applying error mitigation protocol 122 to obtain a more reliable mitigated expectation value than mitigated expectation value 124 of the target circuit 120. That is, as described above, error mitigation protocol 122 can be subject to inaccuracies such as residual bias, inaccurate noise models, or fluctuations in error rates, limiting the accuracy of the mitigated expectation value 124. Thus, the mitigated expectation value 124 can be considered as being unreliable due to an unbounded residual bias error. Accordingly, a method to obtain a boosted mitigated expectation value 126 can be desirable. A boosted mitigated expectation value is a mitigated expectation value where the residual bias error is bounded and the error mitigation protocol applied is asymptotically bias-free. Thus, the boosted mitigated expectation value 126 can be considered as being more accurate than mitigated expectation value 124 that is initially determined with error mitigation protocol 122. As described herein, the classical system 102 can facilitate such asymptotically bias-free error mitigation with bounded bias.

In various embodiments, the decomposition component 206 can decompose the target circuit 120 into an ensemble of circuits 210. In various aspects, the ensemble of circuits 210 can be classically simulable. In various instances, the decomposition component 206 can utilize any suitable method to decompose the target circuit 120 into the ensemble of circuits 210, such as quasi-probability decomposition (QPD), Pauli-based decomposition, gate set decompositions, or Quasi-classical methods.

In any case, the execution component 208 can classically simulate the ensemble of circuits 210 to determine a set of ideal expectation values of the ensemble of circuits 210. Furthermore, the execution component 208 can perform classical executions and quantum executions of the ensemble of circuits 210 to determine a set of mitigated expectation values for the ensemble of circuits 210.

Thereafter, based on the set of ideal expectation values of the ensemble of circuits 210 and the set of mitigated expectation values of the ensemble of circuits 210, the correction component 204 can determine the boosted mitigated expectation value 126. More specifically, by comparing the set of mitigated expectation values of the ensemble of circuits 210 to the set of ideal expectation values (e.g., exact classical simulations), the correction component 204 can estimate the residual bias error of the mitigated expectation value 124 of the target circuit 120.

FIG. 2 illustrates another block diagram of an example, non-limiting system 200 that facilitates asymptotically bias-free error mitigation with bounded residual bias in accordance with one or more embodiments described herein.

In various embodiments, the decomposition component 206 can, as described herein, decompose the target circuit 120 into the ensemble of circuits 210, wherein the ensemble of circuits 210 consists of a set of quantum circuits that are classically simulable. More specifically, for a target observable O and initial state p, the ideal expectation value of p evolved through the target circuit 120 can be defined as [symbol] O [symbol] ≡Tr[ρ [symbol] ^{†}(O)]= [symbol] g( [symbol] )Tr[ρ [symbol] ^{†}(O)], where [symbol] denotes the ensemble of circuits 210, circuits [symbol] are elements of the ensemble of circuits [symbol] , and coefficients g( [symbol] ) define how to combine the expectation values of the ensemble of circuits 210 in order to obtain the boosted mitigated expectation value 126.

As described above, quantum system 112 is inherently noisy, and thus performing the target circuit 120 on the quantum system 112 results in an expectation value that is an inaccurate estimate of the ideal expectation value [symbol] O [symbol] . Error mitigation protocol 122 can be applied to reduce such inaccuracy by producing mitigated expectation value 124 that is a closer estimate to the ideal expectation value [symbol] O [symbol] . The mitigated expectation value 124 from applying error mitigation protocol 122 is denoted by [symbol] O [symbol] _{M}. Due to noise and errors (e.g., inaccurate learning, error drifts, error fluctuations, insufficient expressiveness of model), [symbol] O [symbol] ≠ [symbol] O [symbol] _{M}. That is, there exists an error term 40M (e.g., the residual bias error) such that [symbol] O [symbol] = [symbol] O [symbol] − [symbol] O [symbol] _{M}+ [symbol] O [symbol] _{M}= [symbol] O [symbol] _{M}+ΔO_{M}. In other words, the residual bias error can be defined by ΔO_{M}= [symbol] O [symbol] − [symbol] O [symbol] _{M}.

In various embodiments, the correction component 204 can expand the error term ΔO_{M} as a series sum over the ensemble of circuits 210. First, let

$$〈 O 〉 = {\sum }_{k} {E}^{( k )} and {〈 O 〉}_{M} = {\sum }_{k} {E}_{M}^{( k )} ,$$

where E^{(k)} denotes the ideal expectation values of the ensemble of circuits 210 and

$${E}_{M}^{( k )}$$

denotes the mitigated quantum executions of the ensemble of circuits 210.

In various aspects, the expansion of the error term ΔO_{M} as the series sum over the ensemble of circuits 210 can be defined by the following equation:

$$Δ {O}_{M} = {\sum }_{k} {Δ}^{( k )} = {\sum }_{k} ( {E}^{( k )} - {E}_{M}^{( k )} ) ,$$

$$where {Δ}^{( k )} = {\sum }_{𝒞 ∈ {𝒮}_{k}} ( g [ x , k , 𝒞 ] 〈 {𝒞}^{†} [ O ] 〉 - {g}_{M} [ x , k , 𝒞 ] {〈 {𝒞}^{†} [ O ] 〉}_{M} ) .$$

In the equation, g[x, k, [symbol] ] define coefficients in the series sum expansion, and [symbol] [symbol] ^{†}[O] [symbol] and [symbol] [symbol] ^{†}[O] [symbol] _{M} denote the ideal and mitigated-noisy execution of a circuit [symbol] , respectively.

In various embodiments, the correction component 204 can truncate the error term at a finite order K. Accordingly,

$${〈 O 〉}_{B}^{( K )} = {〈 O 〉}_{M} + Δ {O}_{M}^{( K )} = {〈 O 〉}_{M} + {\sum }_{k \leq K} {Δ}^{( k )} ,$$

causing the residual bias error to be defined by Er^{(K)}=Σ_{k>K}Δ^{(k)}.

Note that, estimating the residual bias error based on quantum and classical executions of the ensemble of circuits 210 can provide a more accurate estimate than only classically simulating the target circuit 120 using the ensemble of circuits 210. This is due to the fact that residual bias error is suppressed compared bias in direct classical simulation. That is, Σ_{k>K}Δ^{(k)}<Σ_{k>K}E^{(k)}, indicating that greater suppression leads to a more accurate initial mitigation result (e.g., mitigated expectation value 124).

In various instances, in the limit where the entire ensemble of circuits 210 is used, then the correction component 204 trivially returns the ideal expectation value as calculated by classical simulation of the series expansion. While this is inefficient, this guarantees that the error mitigation is asymptotically bias free. Thus, the correction component 204 can be considered as transforming the error mitigation protocol 122 into an asymptotically bias free protocol.

Note that, in various instances, the access component 202, the correction component 204, the decomposition component 206, and the execution component 208 can collectively be considered as being error mitigation component 110 of the classical system 102. In various aspects, it should be appreciated that the error mitigation component 110 are described primarily herein as comprising four components (e.g., the access component 202, the decomposition component 206, the execution component 208, and the correction component 204) for ease of explanation and illustration. However, the error mitigation component 110 is not limited to being implemented as exactly such four components in every embodiment. Indeed, in some embodiments, the functionalities described herein of such four components can be combined in any suitable fashions, so as to be implemented in or by fewer than four components (e.g., in some cases, a single component can perform all of the functionalities that are described herein with respect to the access component 202, the correction component 204, the decomposition component 206, and the execution component 208). In other embodiments, the functionalities described herein of such four components can instead be distributed, separated, split, or fragmented in any suitable fashions, so as to be implemented in or by more than four components (e.g., two or more components can facilitate the functionalities that are performable by the access component 202; two or more components can facilitate the functionalities that are performable by the correction component 204; two or more components can facilitate the functionalities that are performable by the decomposition component 206; two or more components can facilitate the functionalities that are performable by the execution component 208).

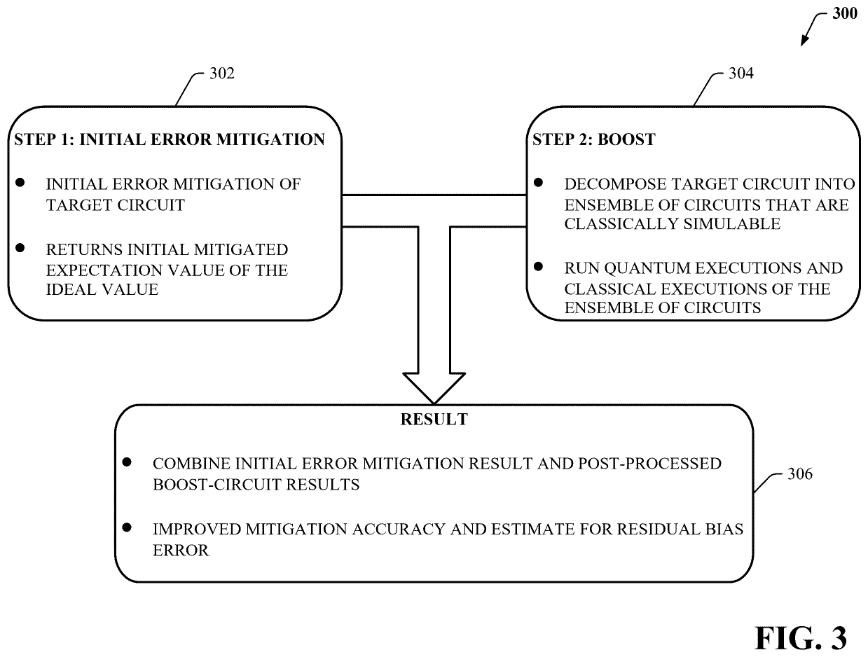

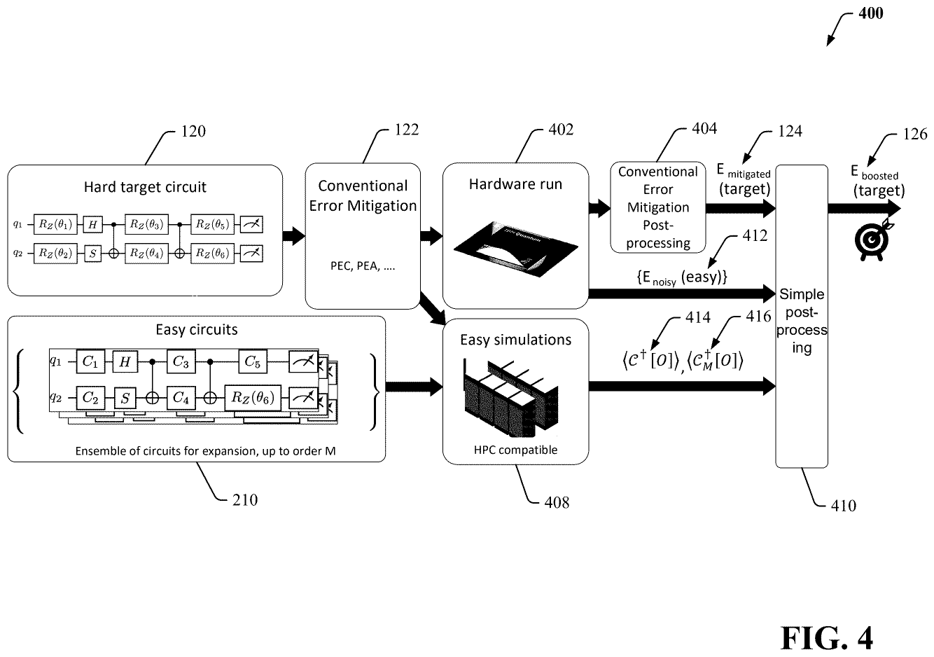

In any case, as described herein, the correction component 204 can determine, based on quantum executions and classical executions of the ensemble of circuits 210, boosted mitigated expectation value 126 that has an increased accuracy from mitigated expectation value 124, bound the residual bias error, and transform error mitigation protocol 122 into an asymptotically bias-free protocol. Such methodology is referred to herein as boosted error mitigation (e.g., a boosted error mitigation protocol). That is, boosted error mitigation can be considered as “boosting” any error mitigation protocol by improving accuracy of the mitigated expectation value by correcting the residual bias error and making the error mitigation protocol asymptotically bias-free. Various non-limiting aspects are described with respect to FIGS. 3 and 4.

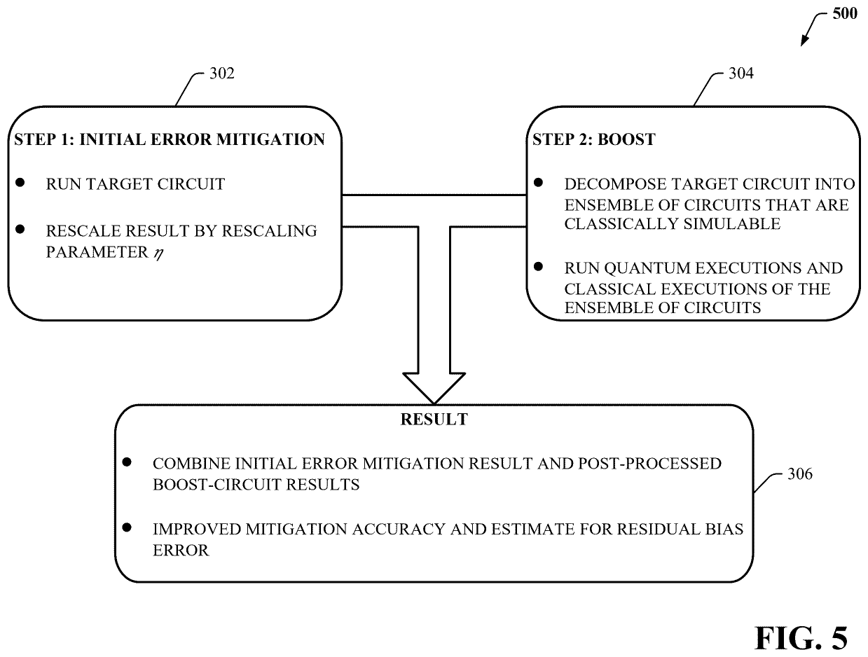

In various instances, the correction component 204 can apply a boosted error mitigation protocol without noise model learning or constraints on the structure of target circuit 120. In particular, the target circuit 120 and the ensemble of circuits 210 can be executed simultaneously on the quantum system 112, where the error mitigation is performed in classical post-processing by rescaling expectation values by a rescaling parameter. Such methodology is referred to herein as circuit average ensemble series expansion rescaling (CAESER). In various aspects, CAESER is particular embodiment of boosted error mitigation. Various non-limiting aspects are described with respect to FIGS. 5-7.

CAESER can provide a number of advantages, including enabling more flexible and implementable bias-free error mitigation than existing bias-free error mitigation protocols, as CAESER does not require layered circuit structures or a separate error model learning stage (e.g., avoids explicit noise modeling or learning of quantum device noise). Further, CEASER reduces the residual bias error at a fixed perturbation series order due to the quantum resources and error mitigation. Moreover, boosted error mitigation and CEASER are suited to scale through hybrid high-performance classical computing (HPC)-quantum workflows. That is, boosted error mitigation and CEASER are designed to efficiently integrate with HPC systems alongside quantum processors, enabling large-scale simulations or computations. This hybrid model allows distributing workloads across classical and quantum resources, making such approach more scalable for complex quantum applications.

FIG. 3 illustrates an example, non-limiting diagram 300 showing asymptotically bias-free error mitigation with bounded residual bias in accordance with one or more embodiments described herein.

In various instances, at step 302, execution component 208 can perform initial error mitigation. More specifically, the execution component 208 can cause the target circuit 120 to be executed or performed by the quantum system 112. In various aspects, the execution component 208 can apply the error mitigation protocol 122 to the target circuit 120, thereby producing mitigated expectation value 124. In various instances, the mitigated expectation value 124 can be considered as the initial mitigated expectation value of the ideal expectation value.

In various embodiments, at step 304, decomposition component 206 can decompose the target circuit 120 into the ensemble of circuits 210. As described above, the ensemble of circuits 210 can be classically simulable. In various aspects, the execution component 208 can cause the ensemble of circuits 210 to be executed or performed by the quantum system 112. Additionally, the ensemble of circuits 210 can classically simulate the ensemble of circuits 210.

Thereafter, at step 306, the correction component 204 can combine the initial mitigated expectation value with the mitigated expectation values produced by the quantum executions and classical executions of the ensemble of circuits 210. This can enable estimation of the residual bias error and thus determination of the boosted mitigated expectation value 126. Various non-limiting aspects are described with respect to FIG. 4.

FIG. 4 illustrates an example, non-limiting diagram 400 showing asymptotically bias-free error mitigation with bounded residual bias in accordance with one or more embodiments described herein.

In various aspects, as described above, the access component 202 can receive the target circuit 120 and error mitigation protocol 122. Furthermore, as described above, the decomposition component 206 can decompose the target circuit 120 into the ensemble of circuits 210. The correction component 204 can select a subset of the ensemble of circuits 210. More specifically, the correction component 204 can select circuits in the ensemble of circuits 210 up to order K in the expansion of the error term ΔO_{M}.

In various embodiments, the execution component 208 can perform quantum executions 402 and classical executions 408 of the ensemble of circuits 210. More specifically, the execution component 208 can execute the ensemble of circuits 210 on the quantum system 112, thereby producing a set of unmitigated expectation values 412 (e.g., set of noisy expectation values 412). The set of unmitigated expectation values are denoted by [symbol] [symbol] ^{†}[O] [symbol] for all [symbol] in all [symbol] ^{(k)} for k<K. Furthermore, the execution component 208 can execute, on quantum system 112, the target circuit 120 using error mitigation protocol 122 and a learnt noise model M, thereby producing the mitigated expectation value 124. The mitigated expectation value 124 (e.g., [symbol] O [symbol] _{M}) is denoted by E_{mitigated}(target) in FIG. 4. In various instances, the correction component 204 can apply conventional error mitigation post-processing to the quantum executions 402 of the target circuit 120 to determine the mitigated expectation value 124.

In various aspects, the execution component 208 can classically simulate the ensemble of circuits 210 to produce a set of ideal expectation values 414 (e.g., [symbol] [symbol] ^{†}[O] [symbol] ) of the ensemble of circuits 210. The set of noisy expectation values 412 produced by the quantum computer are denoted by E_{noisy}(easy) in FIG. 4. Moreover, the execution component 208 can classically simulate the ensemble of circuits 210 using the learnt noise model M to produce a set of noisy unmitigated expectation values 416

$$( e . g . , ( {𝒞}_{M}^{†} [ O ] 〉 )$$

of the ensemble of circuits 210.

In various embodiments, the correction component 204 can perform, at step 410, simple post-processing on the mitigated expectation value 124, set of noisy expectation values 412, the set of ideal expectation values 414, and the set of unmitigated expectation values 416. In various aspects, the correction component 204 can determine the boosted mitigated expectation value 126 based on the mitigated expectation value 124, set of noisy expectation values 412, the set of ideal expectation values 414, and the set of unmitigated expectation values 416. Specifically, the correction component 204 can compute a mitigated expectation value [symbol] [symbol] ^{†}[O] [symbol] _{M} of the ensemble of circuits 210 based on the set of noisy expectation values 412 and the set of unmitigated expectation values 416. In cases where the error mitigation protocol 122 is PEC, PEA, TEM or Clifford classically simulable circuit ensemble (CSCE), the mitigated expectation value can be defined by

$${〈 {𝒞}^{†} [ O ] 〉}_{M} = 〈 {\tilde{𝒞}}^{†} [ O ] 〉 / \vert ( {𝒞}_{M}^{†} [ O ] 〉 \vert .$$

In any case, based on the mitigated expectation value [symbol] [symbol] ^{†}[O] [symbol] _{M}, the correction component 204 can then compute the residual bias error

$$Δ {O}_{M}^{( K )} .$$

Accordingly, using the equation

$${〈 O 〉}_{B}^{( K )} = {〈 O 〉}_{M} + Δ {O}_{M}^{( K )} ,$$

the correction component 204 can determine the boosted mitigated expectation value 126

$$( e . g . , {〈 O 〉}_{B}^{( K )} )$$

based on the determined residual bias error and the

$$( e . g . , Δ {O}_{M}^{( K )} )$$

and the initial mitigated expectation value 124 (e.g., [symbol] O [symbol] _{M}). The boosted mitigated expectation value 126 is denoted by E_{boosted}(target) in FIG. 4.

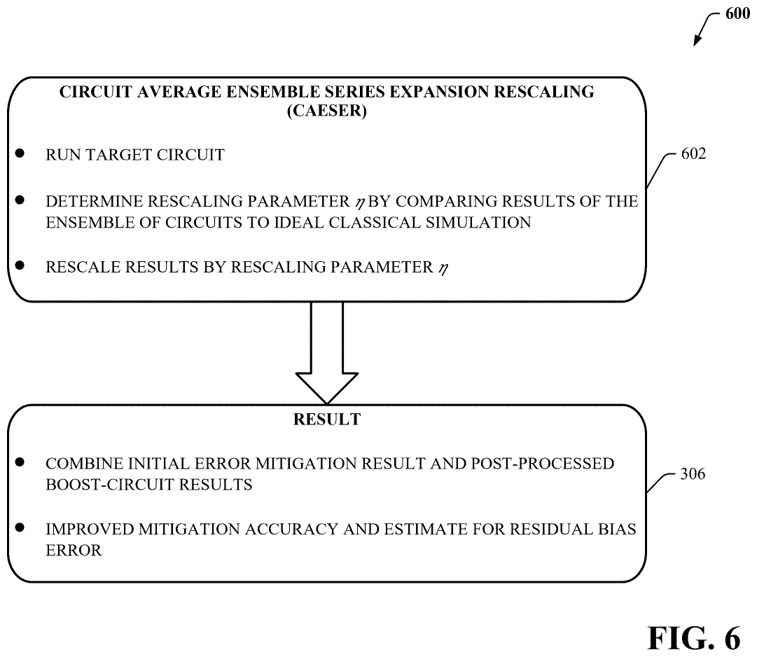

FIGS. 5 and 6 illustrate an example, non-limiting diagrams 500 and 600 showing circuit average ensemble series expansion rescaling in accordance with one or more embodiments described herein.

In various aspects, the correction component 204 can enable determination of the boosted mitigated expectation value 126 without a learning phase. More specifically, during initial error mitigation at step 302, the execution component 208 can cause the target circuit 120 to be executed or performed by the quantum system 112, thereby producing an unmitigated expectation value of the target circuit 120.

Similarly to boosted error mitigation, at step 304, the execution component 208 can classically simulate the ensemble of circuits 210 to determine the set of ideal expectation values 414.

In various aspects, the execution component 208 can further cause the ensemble of circuits 210 to be executed or performed by the quantum system 112, thereby producing the set of unmitigated expectation values 416. Thus, the correction component 204 can determine, at step 302, a rescaling parameter n and rescale the unmitigated expectation value of the target circuit 120 and the set of unmitigated expectation values 416 of the ensemble of circuits 210 by the rescaling parameter. By rescaling the unmitigated expectation value of the target circuit 120, the correction component 204 can obtain the mitigated expectation value 124 of the target circuit 120.

Accordingly, at step 306, the correction component 204 can combine the mitigated expectation value 124 of the target circuit 120 and the rescaled set of unmitigated expectation values 416 of the ensemble of circuits 210. This can enable estimation of the residual bias error and thus determination of the boosted mitigated expectation value 126.

As shown in FIG. 6, the correction component 204 can determine the rescaling parameter based on the quantum executions and the classical executions of the ensemble of circuits 210. More specifically, at step 602, the correction component 204 can determine the rescaling parameter from a distribution of per-circuit rescaling factors

$${η}_{i , k} = T r [ ρ {\tilde{𝒞}}_{i , k}^{†} ( O ) ] / Tr [ {ρ𝒞}_{i , k}^{†} ( O ) ]$$

of the ensemble of circuits 210.

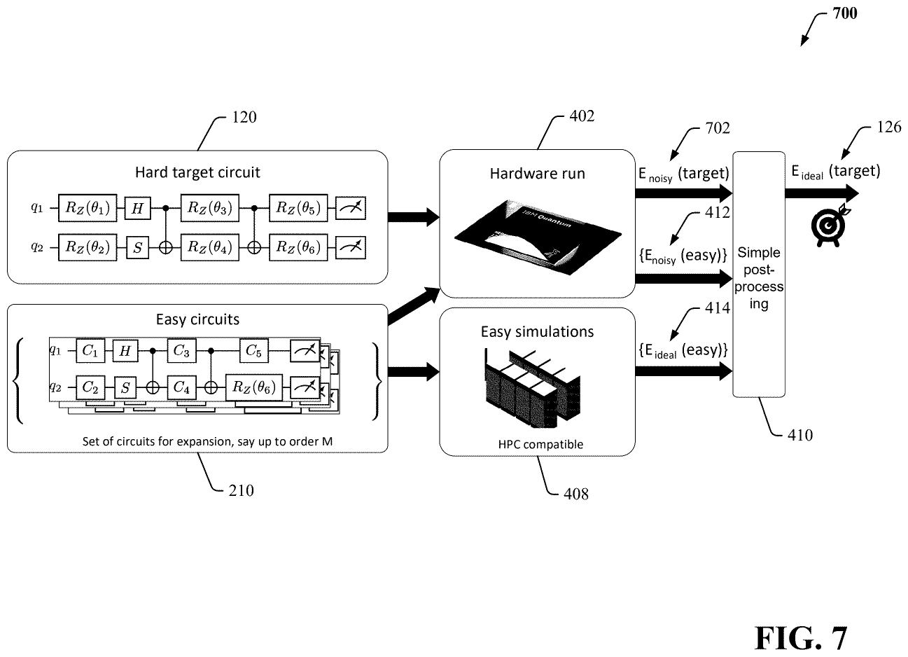

FIG. 7 illustrates an example, non-limiting block diagram 700 showing circuit average ensemble series expansion rescaling in accordance with one or more embodiments described herein.

In various embodiments, instead of performing the error mitigation protocol 122 on the target circuit 120 and the ensemble of circuits 210 as in boosted error mitigation depicted in FIG. 4, CAESER can enable determination of the mitigated expectation value 124 and the set of mitigated expectation values of the ensemble of circuits by rescaling an unmitigated expectation value 702 of the target circuit 120 and the set of unmitigated expectation values 412 of the ensemble of circuits 210 by the rescaling parameter in simple post-processing 410.

To achieve this, the execution component 208 can perform quantum executions 402 of the target circuit 120 and the ensemble of circuits 210 on quantum system 112. That is, the execution component 208 can cause the target circuit 120 and the ensemble of circuits 210 to be executed or performed by the quantum system 112, thereby producing the unmitigated expectation value 702 of the target circuit 120 and the set of unmitigated expectation values 412 of the ensemble of circuits 210. Then, the correction component 204 can rescale the unmitigated expectation value 702 to determine the mitigated expectation value 124 (e.g., [symbol] O [symbol] _{M}= [symbol] O [symbol] /η). Similarly, the correction component 204 can rescale the set of unmitigated expectation values 412 to determine the set of mitigated expectation values of the ensemble of circuits 210 (e.g., [symbol] [symbol] ^{†}[O] [symbol] = [symbol] [symbol] ^{†}[O] [symbol] /η).

Additionally, the execution component 208 can perform classical executions 408 of the ensemble of circuits 210. That is, the execution component 208 can classically simulate the ensemble of circuits 210 to obtain the set of ideal expectation values 414 of the ensemble of circuits 210. The set of ideal expectation values 414 are denoted by E_{ideal}(easy) in FIG. 7.

Thereafter, during simple post-processing 410, the correction component 204 can compute the residual bias error

$$Δ {O}_{M}^{( K )}$$

based on the set of ideal expectation values 414 and the set of mitigated expectation values of the ensemble of circuits 210. Accordingly, using the equation

$${〈 O 〉}_{B}^{( K )} = {〈 O 〉}_{M} + Δ {O}_{M}^{( K )} ,$$

the correction component 204 can determine the boosted mitigated expectation value 126

$$( e . g . , {〈 O 〉}_{B}^{( K )} )$$

based on the determined residual bias error

$$( e . g . , Δ {O}_{M}^{( K )} )$$

and the mitigated expectation value 124 (e.g., [symbol] O [symbol] _{M}).

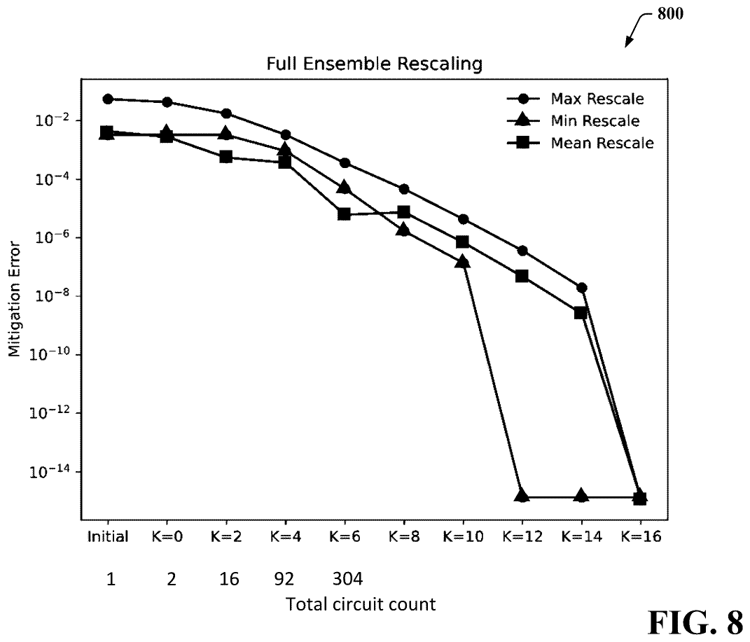

FIG. 8 illustrates an example, non-limiting diagram 800 of simulation results of circuit average ensemble series expansion rescaling in accordance with one or more embodiments described herein.

The non-limiting diagram 800 illustrates experimental results of circuit average ensemble series expansion rescaling of a modified Ising model simulation of 5 qubits for 5 Trotter steps. In particular, the non-limiting diagram 800 illustrates mitigation error against the expansion order K (e.g., total circuit count) for different selections of the rescaling parameter. The maximum rescaling parameter (represented by circles) defines the rescaling parameter as η=max[| [symbol] [symbol] ^{†}[O] [symbol] / [symbol] [symbol] ^{†}[O] [symbol] |]. The minimum rescaling parameter (represented by triangles) defines the rescaling parameter as η=min[| [symbol] [symbol] ^{†}[O] [symbol] / [symbol] [symbol] ^{†}[O] [symbol] |]. The mean rescaling parameter (represented by squares) defines the rescaling parameter as η=mean[| [symbol] [symbol] ^{†}[O] [symbol] / [symbol] [symbol] ^{†}[O] [symbol] |]. As shown, circuit average ensemble series expansion rescaling reduces mitigation error as more circuits of the ensemble of circuits 210 are used, regardless of the choice of the rescaling parameter n.

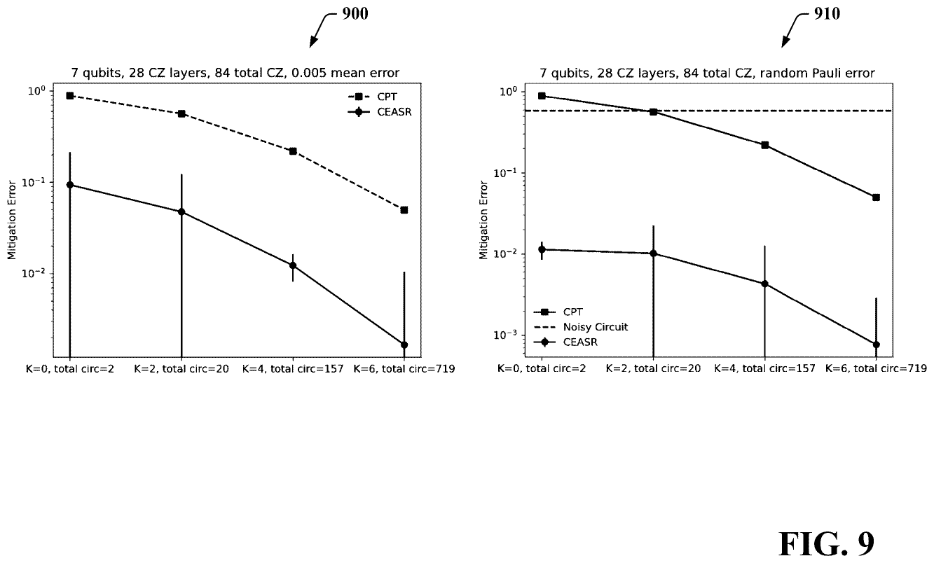

FIG. 9 illustrates an example, non-limiting diagrams 900 and 910 of simulation results of circuit average ensemble series expansion rescaling in accordance with one or more embodiments described herein.

The non-limiting diagrams 900 and 910 illustrate experimental results of circuit average ensemble series expansion rescaling of a modified Ising model simulation of 7 qubits for 7 Trotter steps. In particular, the non-limiting diagram 900 illustrates depolarizing error and the non-limiting diagram 910 illustrates random Pauli error, where the rescaling parameter n is defined as the mean of the ensemble of circuits 210, as defined for FIG. 8. The non-limiting diagrams 900 and 910 compare the performance of circuit average ensemble series rescaling (CEASR) to the classical simulation method Clifford Perturbation Theory (CPT), and the noisy circuit execution. As shown, circuit average ensemble series expansion rescaling exhibits faster convergence to lower residual bias error with fewer circuits.

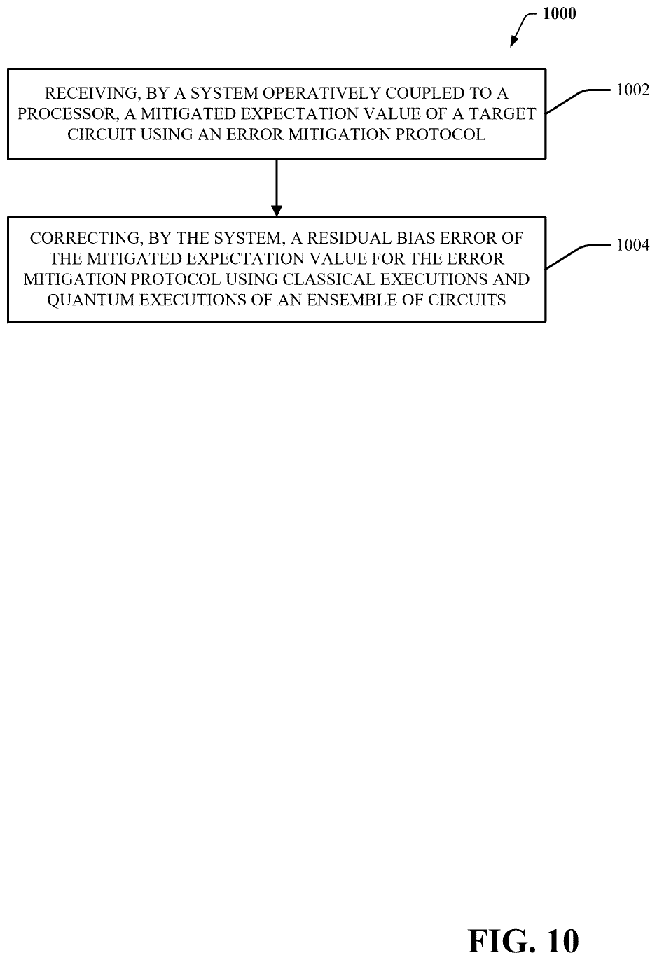

FIG. 10 illustrates a flow diagram of an example, non-limiting computer-implemented method 1000 that can facilitate asymptotically bias-free error mitigation with bounded residual bias in accordance with one or more embodiments described herein. In various cases, the classical system 102 can facilitate the computer-implemented method 1000.

In various embodiments, act 1002 can include receiving, by a system (e.g., via 202) operatively coupled to a processor (e.g., 104), a mitigated expectation value (e.g., 124) of a target circuit (e.g., 120) using an error mitigation protocol (e.g., 122).

In various aspects, act 1004 can include correcting, by the system (e.g., via 204), a residual bias error of the mitigated expectation value for the error mitigation protocol using classical executions (e.g., 402) and quantum executions (e.g., 408) of an ensemble of circuits (e.g., 406).

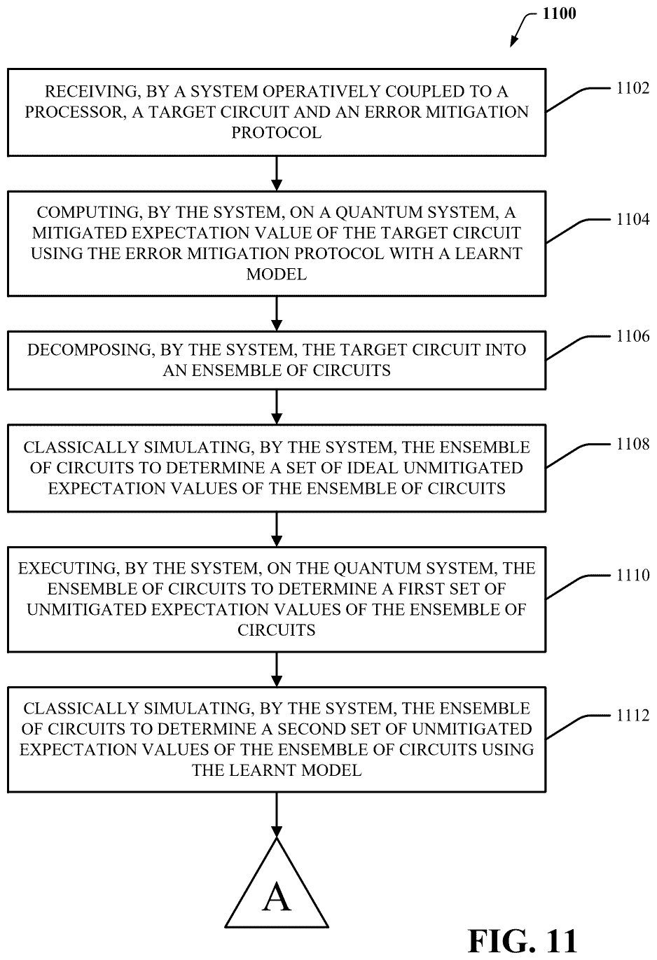

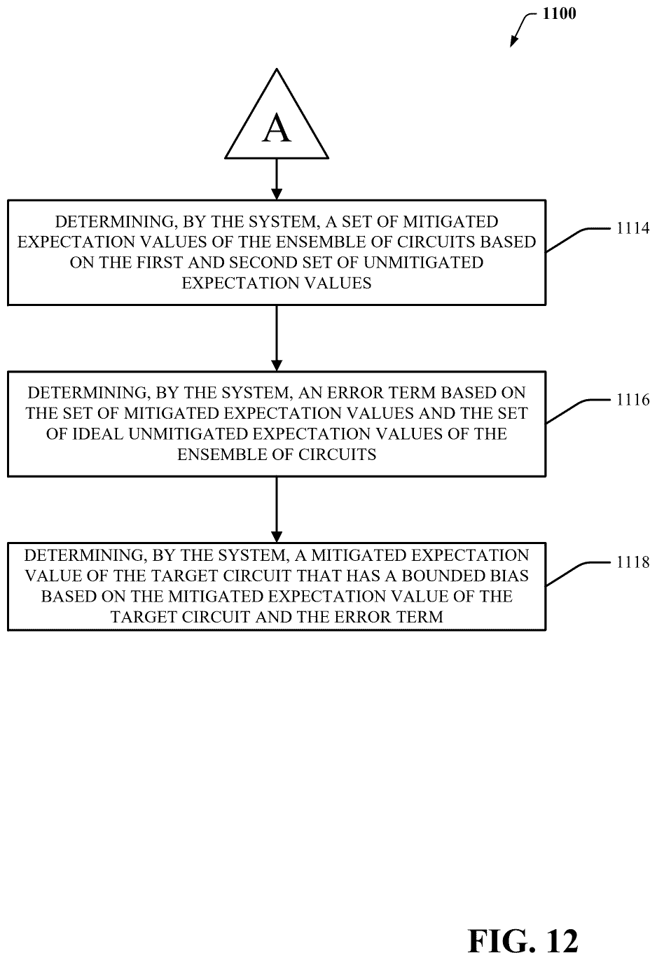

FIGS. 11 and 12 illustrate a flow diagram of an example, non-limiting computer-implemented method 1100 that can facilitate asymptotically bias-free error mitigation with bounded residual bias in accordance with one or more embodiments described herein. In various cases, the classical system 102 can facilitate the computer-implemented method 1100.

In various embodiments, act 1102 can include receiving, by a system (e.g., via 202) operatively coupled to a processor (e.g., 104), a target circuit (e.g., 110) and an error mitigation protocol (e.g., 122).

In various aspects, act 1104 can include computing, by the system (e.g., via 208), on a quantum system (e.g., 112), a mitigated expectation value (e.g., 114) of the target circuit.

In various cases, act 1106 can include decomposing, by the system (e.g., via 208), the target circuit into an ensemble of circuits (e.g., 406).

In various aspects, act 1108 can include classically simulating, by the system (e.g., via 208), the ensemble of circuits to determine a set of ideal unmitigated expectation values of the ensemble of circuits.

In various cases, act 1110 can include executing, by the system (e.g., via 208), on the quantum system, the ensemble of circuits to determine a first set of unmitigated expectation values (e.g., 412) of the ensemble of circuits.

In various embodiments, act 1112 can include classically simulating, by the system (e.g., via 208), the ensemble of circuits to determine a second set of unmitigated expectation values (e.g., 414) of the ensemble of circuits using the learnt model.

In various aspects, act 1114 can include determining, by the system (e.g., via 204), a set of mitigated expectation values of the ensemble of circuits based on the first and second set of unmitigated expectation values.

In various aspects, act 1116 can include determining, by the system (e.g., via 204), an error term based on the set of mitigated expectation values and the set of ideal unmitigated expectation values of the ensemble of circuits.

In various instances, act 1118 can include determining, by the system (e.g., via 204), a mitigated expectation value (e.g. 116) that has a bounded bias based on the mitigated expectation value of the target circuit and the error term.

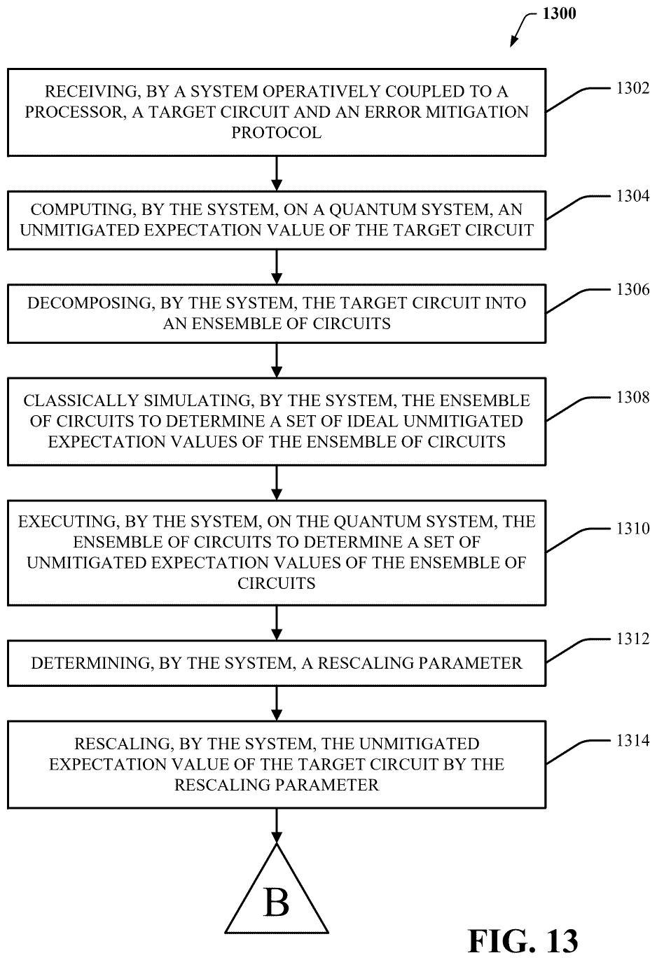

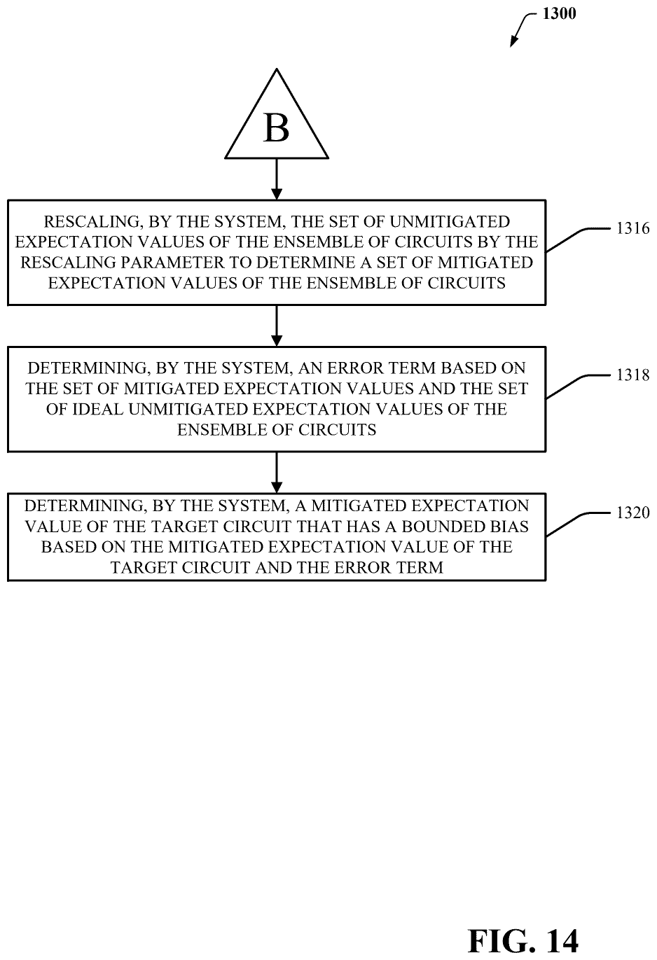

FIGS. 13 and 14 illustrate a flow diagram of an example, non-limiting computer-implemented method 1300 that can facilitate circuit average ensemble series expansion rescaling in accordance with one or more embodiments described herein. In various cases, the classical system 102 can facilitate the computer-implemented method 1300.

In various embodiments, act 1302 can include receiving, by a system (e.g., via 202) operatively coupled to a processor (e.g., 104), a target circuit (e.g., 120) and an error mitigation protocol (e.g., 122).

In various aspects, act 1304 can include computing, by the system (e.g., via 208), on a quantum system (e.g., 112), an unmitigated expectation value (e.g., 702) of the target circuit.

In various cases, act 1306 can include decomposing, by the system (e.g., via 208), the target circuit into an ensemble of circuits (e.g., 406).

In various aspects, act 1308 can include classically simulating, by the system (e.g., via 208), the ensemble of circuits to determine a set of ideal unmitigated expectation values (e.g. 704) of the ensemble of circuits.

In various cases, act 1310 can include executing, by the system (e.g., via 208), on the quantum system, the ensemble of circuits to determine a set of unmitigated expectation values of the ensemble of circuits (e.g., 412).

In various aspects, act 1312 can include determining, by the system (e.g., via 204), a rescaling parameter.

In various cases, act 1313 can include rescaling, by the system (e.g., via 204), the unmitigated expectation value of the target circuit.

In various embodiments, act 1316 can include rescaling, by the system (e.g., via 204), the set of unmitigated expectation values of the ensemble of circuits by the rescaling parameter to determine a set of mitigated expectation values of the ensemble of circuits.

In various aspects, act 1318 can include determining, by the system (e.g., via 204), an error term based on the set of mitigated expectation values and the set of ideal unmitigated expectation values of the ensemble of circuits.

In various instances, act 1320 can include determining, by the system (e.g., via 204), a mitigated expectation value (e.g. 126) that has a bounded bias based on the mitigated expectation value of the ensemble of circuits.

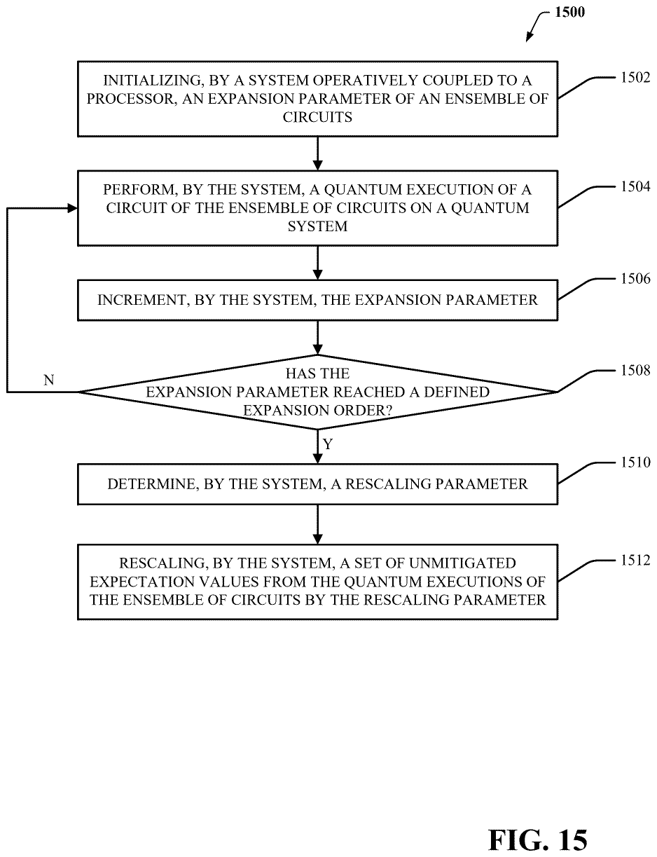

FIG. 15 illustrates a flow diagram of an example, non-limiting computer-implemented method 1500 that can facilitate circuit average ensemble series expansion rescaling in accordance with one or more embodiments described herein. In various cases, the classical system 102 can facilitate the computer-implemented method 1500.

In various embodiments, act 1502 can include initializing, by a system (e.g., via 204) operatively coupled to a processor (e.g., 104), an expansion parameter of an ensemble of circuits (e.g., 406).

In various aspects, act 1504 can include performing, by the system (e.g., via 208), a quantum execution of a circuit of the ensemble of circuits on a quantum system (e.g., 112).

In various cases, act 1506 can include incrementing, by the system (e.g., via 204), the expansion parameter.

In various instances, act 1508 can include determining, by the system (e.g., via 204), if the expansion parameter has reached a defined expansion order. If not, the computer-implemented method 1500 can proceed to act 1504. If so, the computer-implemented method 1500 can proceed to act 1510.

In various aspects, act 1510 can include determining, by the system (e.g., via 204), a rescaling parameter.

In various embodiments, act 1512 can include rescaling, by the system (e.g., via 204), a set of unmitigated expectation values from the quantum executions of the ensemble of circuits by the rescaling parameter.

FIG. 16 and the following discussion are intended to provide a brief, general description of a suitable computing environment 1600 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1600 contains an example of an environment for the execution of at least some of the computer code involved in performing the inventive methods, such as asymptotically bias-free error mitigation with bounded residual bias code 1628. In addition to block 1628, computing environment 1600 includes, for example, computer 1601, wide area network (WAN) 1602, end user device (EUD) 1603, remote server 1604, public cloud 1605, and private cloud 1606. In this embodiment, computer 1601 includes processor set 1610 (including processing circuitry 1620 and cache 1621), communication fabric 1611, volatile memory 1612, persistent storage 1613 (including operating system 1622 and block 1628, as identified above), peripheral device set 1614 (including user interface (UI), device set 1623, storage 1624, and Internet of Things (IoT) sensor set 1625), and network module 1615. Remote server 1604 includes remote database 1630. Public cloud 1605 includes gateway 1640, cloud orchestration module 1641, host physical machine set 1642, virtual machine set 1643, and container set 1644.

COMPUTER 1601 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1630. As is well understood in the art of computer technology, and depending upon the technology, performance of a computer-implemented method can be distributed among multiple computers or between multiple locations. On the other hand, in this presentation of computing environment 1600, detailed discussion is focused on a single computer, specifically computer 1601, to keep the presentation as simple as possible. Computer 1601 can be located in a cloud, even though it is not shown in a cloud in FIG. 16. On the other hand, computer 1601 is not required to be in a cloud except to any extent as can be affirmatively indicated.

PROCESSOR SET 1610 includes one, or more, computer processors of any type now known or to be developed in the future. Processing circuitry 1620 can be distributed over multiple packages, for example, multiple, coordinated integrated circuit chips. Processing circuitry 1620 can implement multiple processor threads or multiple processor cores. Cache 1621 is memory that is located in the processor chip package(s) and is typically used for data or code that should be available for rapid access by the threads or cores running on processor set 1610. Cache memories are typically organized into multiple levels depending upon relative proximity to the processing circuitry. Alternatively, some, or all, of the cache for the processor set can be located “off chip.” In some computing environments, processor set 1610 can be designed for working with qubits and performing quantum computing.

Computer readable program instructions are typically loaded onto computer 1601 to cause a series of operational steps to be performed by processor set 1610 of computer 1601 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1621 and the other storage media discussed below. The program instructions, and associated data, are accessed by processor set 1610 to control and direct performance of the inventive methods. In computing environment 1600, at least some of the instructions for performing the inventive methods can be stored in block 1628 in persistent storage 1613.

COMMUNICATION FABRIC 1611 is the signal conduction path that allows the various components of computer 1601 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1612 is any type of volatile memory now known or to be developed in the future. Examples include dynamic type random access memory (RAM) or static type RAM. Typically, the volatile memory is characterized by random access, but this is not required unless affirmatively indicated. In computer 1601, the volatile memory 1612 is located in a single package and is internal to computer 1601, but, alternatively or additionally, the volatile memory can be distributed over multiple packages or located externally with respect to computer 1601.

PERSISTENT STORAGE 1613 is any form of non-volatile storage for computers that is now known or to be developed in the future. The non-volatility of this storage means that the stored data is maintained regardless of whether power is being supplied to computer 1601 or directly to persistent storage 1613. Persistent storage 1613 can be a read only memory (ROM), but typically at least a portion of the persistent storage allows writing of data, deletion of data and re-writing of data. Some familiar forms of persistent storage include magnetic disks and solid-state storage devices. Operating system 1622 can take several forms, such as various known proprietary operating systems or open-source Portable Operating System Interface type operating systems that employ a kernel. The code included in block 1628 typically includes at least some of the computer code involved in performing the inventive methods.

PERIPHERAL DEVICE SET 1614 includes the set of peripheral devices of computer 1601. Data communication connections between the peripheral devices and the other components of computer 1601 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1623 can include components such as a display screen, speaker, microphone, wearable devices (such as goggles and smart watches), keyboard, mouse, printer, touchpad, game controllers, and haptic devices. Storage 1624 is external storage, such as an external hard drive, or insertable storage, such as an SD card. Storage 1624 can be persistent or volatile. In some embodiments, storage 1624 can take the form of a quantum computing storage device for storing data in the form of qubits. In embodiments where computer 1601 is required to have a large amount of storage (for example, where computer 1601 locally stores and manages a large database) then this storage can be provided by peripheral storage devices designed for storing large amounts of data, such as a storage area network (SAN) that is shared by multiple, geographically distributed computers. IoT sensor set 1625 is made up of sensors that can be used in Internet of Things applications. For example, one sensor can be a thermometer and another sensor can be a motion detector.

NETWORK MODULE 1615 is the collection of computer software, hardware, and firmware that allows computer 1601 to communicate with other computers through WAN 1602. Network module 1615 can include hardware, such as modems or Wi-Fi signal transceivers, software for packetizing or de-packetizing data for communication network transmission, or web browser software for communicating data over the internet. In some embodiments, network control functions and network forwarding functions of network module 1615 are performed on the same physical hardware device. In other embodiments (for example, embodiments that utilize software-defined networking (SDN)), the control functions and the forwarding functions of network module 1615 are performed on physically separate devices, such that the control functions manage several different network hardware devices. Computer readable program instructions for performing the inventive methods can typically be downloaded to computer 1601 from an external computer or external storage device through a network adapter card or network interface included in network module 1615.

WAN 1602 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1603 is any computer system that is used and controlled by an end user (for example, a customer of an enterprise that operates computer 1601) and can take any of the forms discussed above in connection with computer 1601. EUD 1603 typically receives helpful and useful data from the operations of computer 1601. For example, in a hypothetical case where computer 1601 is designed to provide a recommendation to an end user, this recommendation would typically be communicated from network module 1615 of computer 1601 through WAN 1602 to EUD 1603. In this way, EUD 1603 can display, or otherwise present, the recommendation to an end user. In some embodiments, EUD 1603 can be a client device, such as thin client, heavy client, mainframe computer or desktop computer.

REMOTE SERVER 1604 is any computer system that serves at least some data or functionality to computer 1601. Remote server 1604 can be controlled and used by the same entity that operates computer 1601. Remote server 1604 represents the machine(s) that collect and store helpful and useful data for use by other computers, such as computer 1601. For example, in a hypothetical case where computer 1601 is designed and programmed to provide a recommendation based on historical data, then this historical data can be provided to computer 1601 from remote database 1630 of remote server 1604.

PUBLIC CLOUD 1605 is any computer system available for use by multiple entities that provides on-demand availability of computer system resources or other computer capabilities, especially data storage (cloud storage) and computing power, without direct active management by the scale. The direct and active management of the computing resources of public cloud 1605 is performed by the computer hardware or software of cloud orchestration module 1641. The computing resources provided by public cloud 1605 are typically implemented by virtual computing environments that run on various computers making up the computers of host physical machine set 1642, which is the universe of physical computers in or available to public cloud 1605. The virtual computing environments (VCEs) typically take the form of virtual machines from virtual machine set 1643 or containers from container set 1644. It is understood that these VCEs can be stored as images and can be transferred among and between the various physical machine hosts, either as images or after instantiation of the VCE. Cloud orchestration module 1641 manages the transfer and storage of images, deploys new instantiations of VCEs and manages active instantiations of VCE deployments. Gateway 1640 is the collection of computer software, hardware and firmware allowing public cloud 1605 to communicate through WAN 1602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1606 is similar to public cloud 1605, except that the computing resources are only available for use by a single enterprise. While private cloud 1606 is depicted as being in communication with WAN 1602, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1605 and private cloud 1606 are both part of a larger hybrid cloud.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an access component that receives a mitigated expectation value of a target circuit using an error mitigation protocol;
a correction component that corrects a residual bias error of the mitigated expectation value for the error mitigation protocol using classical executions and quantum executions of an ensemble of circuits.

2. The system of claim 1, wherein the correction component transforms the error mitigation protocol into an asymptotically bias free protocol.

3. The system of claim 1, wherein the computer executable components further comprise:
a decomposition component that decomposes the target circuit into the ensemble of circuits, wherein the ensemble of circuits is classically simulable.

4. The system of claim 1, wherein the computer executable components further comprise:
an execution component that applies the error mitigation protocol to the ensemble of circuits.

5. The system of claim 1, wherein an execution component performs the quantum executions of the ensemble of circuits or quantum executions of the target circuit simultaneously on a quantum processor.

6. The system of claim 1, wherein the correction component determines a set of mitigated expectation values of the ensemble of circuits based on the classical executions and quantum executions of the ensemble of circuits.

7. The system of claim 6, wherein an execution component classically simulates the ensemble of circuits to determine a set of ideal expectation values of the ensemble of circuits.

8. The system of claim 7, wherein the correction component determines an error term based on the set of mitigated expectation values of the ensemble of circuits and the set of ideal expectation values of the ensemble of circuits.

9. The system of claim 8, wherein correcting the residual bias error of the mitigated expectation value comprises:
determining a second mitigated expectation value of the target circuit that has a bounded bias based on the mitigated expectation value of the target circuit and the error term.

10. The system of claim 6, wherein an execution component executes the ensemble of circuits on a quantum processor to determine a first set of unmitigated expectation values of the ensemble of circuits and classically simulates the ensemble of circuits using a noise model to determine a second set of unmitigated expectation values of the ensemble of circuits, and wherein the correction component determines the set of mitigated expectation values of the ensemble of circuits based on the first and second set of unmitigated expectation values.

11. The system of claim 6, wherein the correction component determines a rescaling parameter based on the classical executions and quantum executions of the ensemble of circuits.

12. The system of claim 11, wherein the correction component rescales an unmitigated expectation value of the target circuit by the rescaling parameter.

13. The system of claim 11, wherein the correction component rescales a set of unmitigated expectation values of the ensemble of circuits by the rescaling parameter.

14. The system of claim 8, wherein the correction component expands the error term as a series sum over the ensemble of circuits.

15. A computer-implemented method, comprising:
receiving, by a system operatively coupled to a processor, a mitigated expectation value of a target circuit using an error mitigation protocol; and
correct, by the system, a residual bias error of the mitigated expectation value for the error mitigation protocol using classical executions and quantum executions of an ensemble of circuits.

16. The computer-implemented method of claim 15, further comprising:
transforming, by the system, the error mitigation protocol into an asymptotically bias free protocol.

17. The computer-implemented method of claim 15, further comprising:
decomposing, by the system, the target circuit into the ensemble of circuits, wherein the ensemble of circuits is classically simulable.

18. The computer-implemented method of claim 15, further comprising:
performing, by the system, the quantum executions of the ensemble of circuits or quantum executions of the target circuit simultaneously on a quantum processor;
determining, by the system, a set of mitigated expectation values of the ensemble of circuits based on the classical executions and quantum executions of the ensemble of circuits; and
determining, by the system, an error term based on the set of mitigated expectation values of the ensemble of circuits and a set of ideal expectation values of the ensemble of circuits.

19. A computer program product for boosted error mitigation with enhanced accuracy, the computer program product comprising a computer readable storage medium having program instructions embodied therewith, the program instructions executable by a processor to cause the processor to:
receive, by the processor, a mitigated expectation value of a target circuit using an error mitigation protocol; and
correct, by the processor, a residual bias error of the mitigated expectation value for the error mitigation protocol using classical executions and quantum executions of an ensemble of circuits.

20. The computer program product of claim 19, wherein the program instructions are further executable by the processor to cause the processor to:
transform, by the processor, the error mitigation protocol into an asymptotically bias free protocol.
